(19) United States
(12) Patent Application Publication
(10) Pub. No.: US 2024/0429825 A1
(43) Pub. Date: Dec. 26, 2024

(54) ISOLATED POWER SUPPLY APPARATUS

(71) Applicant: DENSO CORPORATION, Kariya-city (JP)

(72) Inventors: Takeshi HIRANO, Kariya-city (JP); Hitoshi OZAKI, Kariya-city (JP); Akira TOKUMASU, Kariya-city (JP); Atsuki ASANO, Kariya-city (JP)

(73) Assignee: DENSO CORPORATION, Kariya-city (JP)

(21) Appl. No.: 18/822,907

(22) Filed: Sep. 3, 2024

Related U.S. Application Data
(63) Continuation of application No. PCT/JP2023/003400, filed on Feb. 2, 2023.

(30) Foreign Application Priority Data
Mar. 2, 2022 (JP) 2022-032151

(51) Int. Cl. H02M 3/335

(52) U.S. Cl. CPC H02M 3/33523

(57) ABSTRACT

An isolated power supply apparatus includes transformers, input sides of which are connected with a DC power source and output sides of which are connected with power supply targets corresponding to the transformers. At least two of the transformers have respective feedback windings. The apparatus further includes: a control switch configured to allow supply of electric power from the DC power source to the input sides of the transformers by being turned on and interrupt the supply of electric power from the DC power source to the input sides of the transformers by being turned off; an acquisition unit configured to acquire a control value based on voltages generated in the feedback windings; and a control unit configured to turn on and off the control switch so as to feedback-control the control value to a target value and thereby control voltages on the output sides of the transformers.

### CROSS-REFERENCE TO RELATED APPLICATIONS

The present application is a continuation application of International Application No. PCT/JP2023/003400 filed on Feb. 2, 2023, which is based on and claims priority from Japanese Patent Application No. 2022-032151 filed on Mar. 2, 2022. The entire contents of these applications are incorporated by reference into the present application.

### BACKGROUND

### 1 Technical Field

The present disclosure relates to isolated power supply apparatuses.

### 2 Description of Related Art

There are known isolated power supply apparatuses applied to systems that include a DC power source and a plurality of power supply targets; these isolated power supply apparatuses are configured to supply electric power from the DC power source to the power supply targets while electrically isolating the DC power source from the power supply targets. For example, Japanese Patent No. JP 6817298 B2 discloses an isolated power supply apparatus that includes a plurality of transformers. For each of the transformers, the input side of the transformer is connected with the DC power source, whereas the output side of the transformer is connected with one of the power supply targets which corresponds to the transformer. Moreover, for each of the transformers, the voltage on the output side of the transformer is controlled by controlling the voltage of the DC power source applied to the input side of the transformer.

### SUMMARY

A feedback winding may be provided in one of the transformers. In this case, the isolated power supply apparatus may acquire the voltage generated in the feedback winding as a control value, and perform feedback control of controlling the acquired control value to a target value. However, there is a concern that the output voltages of the transformers may become excessively higher or excessively lower than a target output voltage due to the transformer in which the feedback winding is provided, thereby lowering the controllability of the output voltages of the transformers.

The present disclosure has been accomplished in view of the above circumstances.

According to a first aspect of the present disclosure, there is provided an isolated power supply apparatus which includes a plurality of transformers, a control switch, an acquisition unit and a control unit. Input sides of the transformers are connected with a DC power source; and output sides of the transformers are connected with power supply targets corresponding to the transformers. At least two of the transformers have respective feedback windings. The control switch is configured to allow supply of electric power from the DC power source to the input sides of the transformers by being turned on and interrupt the supply of electric power from the DC power source to the input sides of the transformers by being turned off. The acquisition unit is configured to acquire, based on voltages generated in the feedback windings, a control value for feedback control. The control unit is configured to turn on and off the control switch so as to feedback-control the control value to a target value and thereby control voltages on the output sides of the transformers.

In the case of a feedback winding being provided in only one of the transformers, the number of transformers whose output voltages are reflected in the control value would be reduced due to the fact that only one of the transformers is provided with the feedback winding. Consequently, the output voltages of those of the transformers which are not provided with the feedback winding might become excessively higher or excessively lower than the target output voltage.

In view of the above, according to the first aspect of the present disclosure, the control value is acquired based on the voltages generated in the feedback windings provided in at least two of the transformers. Consequently, it becomes possible to perform the feedback control with the control value reflecting the output voltages of more transformers than in the case of the control value being acquired based on the voltage generated in a feedback winding provided in only one of the transformers. Hence, it becomes possible to prevent the output voltages of the transformers from becoming excessively higher or excessively lower than the target output voltage. As a result, it becomes possible to improve the controllability of the output voltages of the transformers.

According to a second aspect of the present disclosure, there is provided an isolated power supply apparatus which includes a plurality of transformers, a control switch, an acquisition unit and a control unit. Input sides of the transformers are connected with a DC power source; and output sides of the transformers are connected with power supply targets corresponding to the transformers. At least two of the transformers have different numbers of the power supply targets connected therewith. A specific transformer, which has a maximum number of the power supply targets connected with the output side thereof among the transformers, has a feedback winding. The control switch is configured to allow supply of electric power from the DC power source to the input sides of the transformers by being turned on and interrupt the supply of electric power from the DC power source to the input sides of the transformers by being turned off. The acquisition unit is configured to acquire, based on a voltage generated in the feedback winding, a control value for feedback control. The control unit is configured to turn on and off the control switch so as to feedback-control the control value to a target value and thereby control voltages on the output sides of the transformers.

In the case of a feedback winding being provided in only one of the transformers, the output voltages of the transformers may change significantly due to load fluctuation in the power supply target(s) connected with the output side of the transformer in which the feedback winding is provided. Specifically, when the power supply target(s) stop(s) operating or operate(s) under a high load, the output voltage of the transformer connected with the power supply target(s) may change significantly. Moreover, when the transformers have different numbers of the power supply targets connected therewith, overall load fluctuation in the power supply target(s) connected with the output side of a first transformer may be reduced compared to overall load fluctuation in the power supply target(s) connected with the output side of a second transformer; the number of the power supply target(s) connected with the output side of the first transformer is greater than the number of the power supply target(s) connected with the output side of the second transformer. Therefore, it may be desirable to acquire, as the control value, the voltage generated in a feedback winding provided in one of the transformers which has the maximum number of the power supply targets connected with the output side thereof.

In view of the above, according to the second aspect of the present disclosure, the feedback winding is provided in the specific transformer which has the maximum number of the power supply targets connected with the output side thereof among the transformers. Consequently, compared to the case of a feedback winding being provided in only one of the other transformers than the specific transformer, it becomes possible to suppress overall load fluctuation in the power supply targets connected with the output side of the specific transformer, thereby suppressing change in the output voltage of the specific transformer. Thus, it also becomes possible to suppress change in the voltage generated in the feedback winding, thereby suppressing change in the control value. Hence, it becomes possible to suppress the deviation of the control value from the target value, thereby suppressing increase in the amount of change in the output voltages of the transformers during the feedback control. As a result, it becomes possible to prevent the output voltages of the transformers from becoming excessively higher or excessively lower than the target output voltage, thereby improving the controllability of the output voltages of the transformers.

### BRIEF DESCRIPTION OF THE DRAWINGS

FIG. 1 is an overall configuration diagram of a system according to a first embodiment.

FIG. 2 is a diagram illustrating the configuration of an isolated power supply apparatus according to the first embodiment.

FIG. 3 is a plan view of a board to which the isolated power supply apparatus according to the first embodiment is mounted.

FIG. 4 is a diagram illustrating the configuration of an isolated power supply apparatus according to a second embodiment.

FIG. 5 is a diagram illustrating the configuration of an isolated power supply apparatus according to a third embodiment.

FIG. 6 is a diagram illustrating the configuration of an isolated power supply apparatus according to a fourth embodiment.

### DESCRIPTION OF EMBODIMENTS

### First Embodiment

Hereinafter, a first embodiment embodying an isolated power supply apparatus according to the present disclosure will be described with reference to the drawings. The isolated power supply apparatus according to the present embodiment is installed in a vehicle such as a hybrid vehicle.

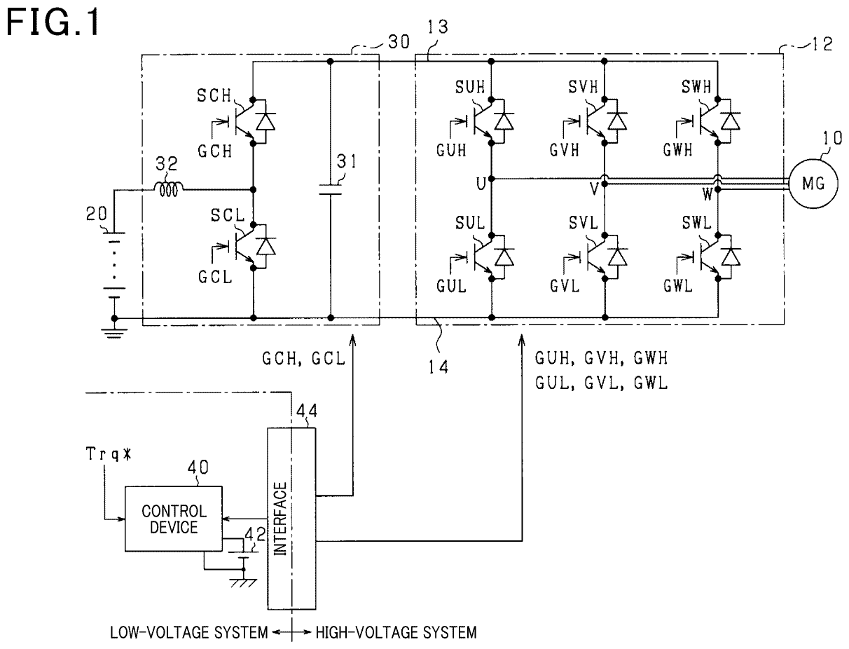

As shown in FIG. 1, a system according to the present embodiment includes a motor-generator 10, an inverter 12, a boost converter 30 and a control device 40. The motor-generator 10 is connected, via a power division mechanism (not shown), with drive wheels and an engine that serves as an in-vehicle main machine. Moreover, the motor-generator 10 is also connected with the inverter 12 and serves as an in-vehicle main machine. The inverter 12, which is a three-phase inverter, is connected with a high-voltage battery 20 (e.g., a lithium-ion secondary battery or a nickel-hydrogen secondary battery) via the boost converter 30.

The boost converter 30 includes a smoothing capacitor 31, a reactor 32, an upper-arm boost switch SCH and a lower-arm boost switch SCL. In the present embodiment, voltage-controlled semiconductor switches, more particularly IGBTs, are employed as the upper-arm boost switch SCH and the lower-arm boost switch SCL. Moreover, each of the switches SCH and SCL has a freewheel diode connected in antiparallel thereto.

An emitter of the upper-arm boost switch SCH is connected with a collector of the lower-arm boost switch SCL. To a collector of the upper-arm boost switch SCH, there is connected a first end of the smoothing capacitor 31. To an emitter of the lower-arm boost switch SCL, there are connected both a second end of the smoothing capacitor 31 and a negative terminal of the high-voltage battery 20. Consequently, a series connection unit consisting of the boost switches SCH and SCL is connected in parallel to the smoothing capacitor 31. Moreover, both the emitter of the upper-arm boost switch SCH and the collector of the lower-arm boost switch SCL are connected, via the reactor 32, with a positive terminal of the high-voltage battery 20. The boost converter 30 boosts an output voltage of the high-voltage battery 20 by turning on and off each of the boost switches SCH and SCL.

The inverter 12 includes series connection units of three phases; each of the series connection units consists of one of upper-arm switches SUH, SVH and SWH and one of lower-arm switches SUL, SVL and SWL. In the present embodiment, voltage-controlled semiconductor switches, more particularly IGBTs, are employed as the switches SUH to SWL. Moreover, each of the switches SUH to SWL has a freewheel diode connected in antiparallel thereto.

An emitter of the U-phase upper-arm switch SUH is connected with a collector of the U-phase lower-arm switch SUL. A junction point between the U-phase upper-arm switch SUH and the U-phase lower-arm switch SUL is connected with a U-phase input terminal of the motor-generator 10. An emitter of the V-phase upper-arm switch SVH is connected with a collector of the V-phase lower-arm switch SVL. A junction point between the V-phase upper-arm switch SVH and the V-phase lower-arm switch SVL is connected with a V-phase input terminal of the motor-generator 10. An emitter of the W-phase upper-arm switch SWH is connected with a collector of the W-phase lower-arm switch SWL. A junction point between the W-phase upper-arm switch SWH and the W-phase lower-arm switch SWL is connected with a W-phase input terminal of the motor-generator 10.

Collectors of the upper-arm switches SUH to SWH are connected with each other by a positive bus 13 such as a busbar. Moreover, the positive bus 13 is connected with the collector of the upper-arm boost switch SCH and the first end of the smoothing capacitor 31. On the other hand, emitters of the lower-arm switches SUL to SWL are connected with each other by a negative bus 14 such as a busbar. Moreover, the negative bus 14 is connected with the emitter of the lower-arm boost switch SCL, the second end of the smoothing capacitor 31 and the negative terminal of the high-voltage battery 20.

The control device 40, which is implemented by a microcomputer, is driven by electric power supplied from a low-voltage battery 42 that serves as a DC power source. The control device 40 operates the inverter 12 and the boost converter 30 so as to control the torque of the motor-generator 10 to a command torque Trq*. Specifically, to turn on and off the switches SUH to SWL that constitute the inverter 12, the control device 40 generates operation signals GUH to GWL and outputs them to drive circuits of the switches SUH to SWL. Moreover, to turn on and off the switches SCH and SCL that constitute the boost converter 30, the control device 40 generates operation signals GCH and GCL and outputs them to drive circuits of the switches SCH and SCL.

The low-voltage battery 42 is a storage battery whose output voltage is lower than the output voltage of the high-voltage battery 20. The low-voltage battery 42 may be implemented by, for example, a lead-acid battery. In addition, in the present embodiment, the low-voltage battery 42 corresponds to a “DC power source”.

An interface unit 44 has a function of transmitting signals between a high-voltage system and a low-voltage system while electrically isolating between them; the high-voltage system includes the motor-generator 10, the inverter 12, the boost converter 30 and the high-voltage battery 20, whereas the low-voltage system includes the control device 40 and the low-voltage battery 42. The interface unit 44 may be implemented by, for example, a photocoupler.

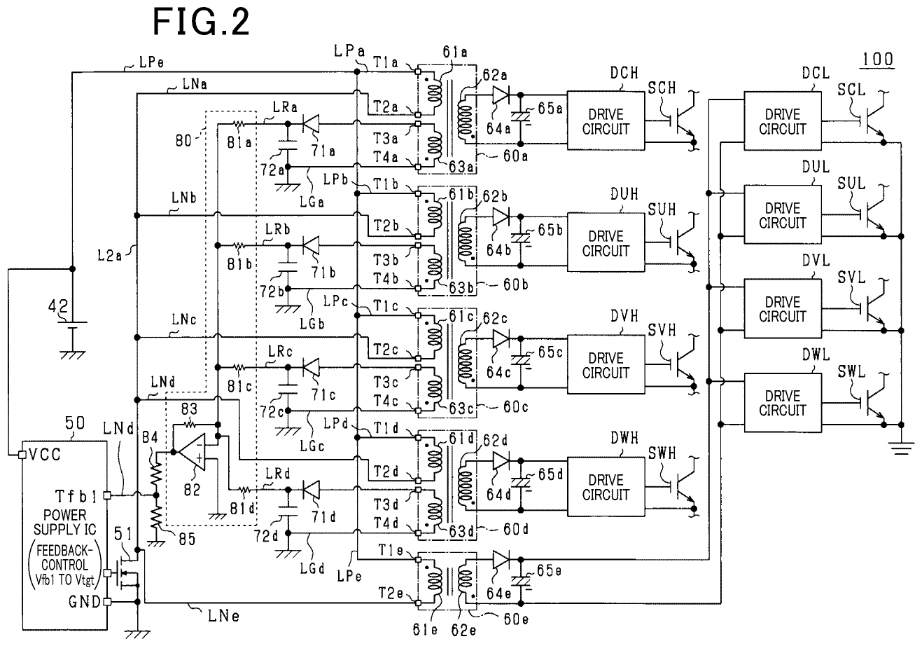

Next, the isolated power supply apparatus 100 according to the present embodiment will be described with reference to FIG. 2. The isolated power supply apparatus 100 has a function of supplying electric power to the drive circuits DCH, DCL and DUH to DWL that respectively drive the switches SCH, SCL and SUH to SWL, while providing isolation between the high-voltage system and the low-voltage system. In the present embodiment, the isolated power supply apparatus 100 is configured as a flyback type switching power supply.

The isolated power supply apparatus 100 includes a power supply IC 50 and a control switch 51. The power supply IC 50 is configured to turn on and off the control switch 51. The control switch 51 is implemented by a voltage-controlled semiconductor switch, more particularly by an N-channel MOSFET.

The isolated power supply apparatus 100 also includes a plurality of upper-arm transformers that supply electric power respectively to the upper-arm drive circuits DCH, DUH, DVH and DWH, and a lower-arm transformer that supplies electric power to the lower-arm drive circuits DCL, DUL, DVL and DWL. That is, the plurality of upper-arm transformers are provided individually respectively corresponding to the upper-arm switches SCH, SUH, SVH and SWH. On the other hand, the lower-arm transformer is provided as a common transformer to all the lower-arm switches SCL, SUL, SVL and SWL.

Specifically, the plurality of upper-arm transformers are first to fourth transformers 60a, 60b, 60c and 60d; and the lower-arm transformer is a fifth transformer 60e. The first transformer 60a is configured to supply electric power to the boost upper-arm drive circuit DCH. The second transformer 60b is configured to supply electric power to the U-phase upper-arm drive circuit DUH. The third transformer 60c is configured to supply electric power to the V-phase upper-arm drive circuit DVH. The fourth transformer 60d is configured to supply electric power to the W-phase upper-arm drive circuit DWH. The fifth transformer 60e is configured to supply electric power to the boost lower-arm drive circuit DCL and the U-phase, V-phase and W-phase lower-arm drive circuits DUL, DVL and DWL. In addition, in the present embodiment, each of the drive circuits DCH, DCL and DUH to DWL corresponds to a “power supply target”.

The first transformer 60a includes a first input winding 61a, a first output winding 62a and a first feedback winding 63a. Moreover, the first transformer 60a also includes a common core around which the windings 61a, 62a and 63a are wound; and the windings 61a, 62a and 63a are magnetically coupled by the common core.

Similar to the first transformer 60a, the second transformer 60b includes a second input winding 61b, a second output winding 62b and a second feedback winding 63b that are magnetically coupled by a common core. Similar to the first transformer 60a, the third transformer 60c includes a third input winding 61c, a third output winding 62c and a third feedback winding 63c that are magnetically coupled by a common core. Similar to the first transformer 60a, the fourth transformer 60d includes a fourth input winding 61d, a fourth output winding 62d and a fourth feedback winding 63d that are magnetically coupled by a common core.

The fifth transformer 60e includes a fifth input winding 61e and a fifth output winding 62e. Moreover, the fifth transformer 60e also includes a common core around which the windings 61e and 62e are wound; and the windings 61e and 62e are magnetically coupled by the common core.

In each of the transformers 60a to 60e, there are provided a plurality of terminals. Specifically, to each of the output terminals of the first to fifth transformers 60a to 60e, there is connected a corresponding one of the first to fifth output windings 62a to 62e.

A first terminal T1a of the first transformer 60a is connected with a second terminal T2a of the first transformer 60a via the first input winding 61a. A third terminal T3a of the first transformer 60a is connected with a fourth terminal T4a of the first transformer 60a via the first feedback winding 63a. Upon the control switch 51 being turned on and thereby the electric potential of the first terminal T1a of the first transformer 60a becoming higher than the electric potential of the second terminal T2a, an induced voltage is generated in the first feedback winding 63a so that the electric potential of the fourth terminal T4a of the first transformer 60a becomes higher than the electric potential of the third terminal T3a. In this case, electric current is restricted by a first feedback diode 71a from flowing through the first feedback winding 63a; thus, magnetic energy is stored in the first input winding 61a. Further, upon the control switch 51 being turned from on to off, electric current is caused by the magnetic energy stored in the first input winding 61a to flow through the first feedback winding 63a. Moreover, as in the case of the first feedback winding 63a, upon the control switch 51 being turned from on to off, electric current is caused by the magnetic energy stored in the first input winding 61a to flow through the first output winding 62a as well.

A first terminal T1b of the second transformer 60b is connected with a second terminal T2b of the second transformer 60b via the second input winding 61b. A third terminal T3b of the second transformer 60b is connected with a fourth terminal T4b of the second transformer 60b via the second feedback winding 63b. Upon the control switch 51 being turned on and thereby the electric potential of the first terminal T1b of the second transformer 60b becoming higher than the electric potential of the second terminal T2b, an induced voltage is generated in the second feedback winding 63b so that the electric potential of the fourth terminal T4b of the second transformer 60b becomes higher than the electric potential of the third terminal T3b. In this case, electric current is restricted by a second feedback diode 71b from flowing through the second feedback winding 63b; thus, magnetic energy is stored in the second input winding 61b. Further, upon the control switch 51 being turned from on to off, electric current is caused by the magnetic energy stored in the second input winding 61b to flow through the second feedback winding 63b. Moreover, as in the case of the second feedback winding 63b, upon the control switch 51 being turned from on to off, electric current is caused by the magnetic energy stored in the second input winding 61b to flow through the second output winding 62b as well.

A first terminal T1c of the third transformer 60c is connected with a second terminal T2c of the third transformer 60c via the third input winding 61c. A third terminal T3c of the third transformer 60c is connected with a fourth terminal T4c of the third transformer 60c via the third feedback winding 63c. Upon the control switch 51 being turned on and thereby the electric potential of the first terminal T1c of the third transformer 60c becoming higher than the electric potential of the second terminal T2c, an induced voltage is generated in the third feedback winding 63c so that the electric potential of the fourth terminal T4c of the third transformer 60c becomes higher than the electric potential of the third terminal T3c. In this case, electric current is restricted by a third feedback diode 71c from flowing through the third feedback winding 63c; thus, magnetic energy is stored in the third input winding 61c. Further, upon the control switch 51 being turned from on to off, electric current is caused by the magnetic energy stored in the third input winding 61c to flow through the third feedback winding 63c. Moreover, as in the case of the third feedback winding 63c, upon the control switch 51 being turned from on to off, electric current is caused by the magnetic energy stored in the third input winding 61c to flow through the third output winding 62c as well.

A first terminal T1d of the fourth transformer 60d is connected with a second terminal T2d of the fourth transformer 60d via the fourth input winding 61d. A third terminal T3d of the fourth transformer 60d is connected with a fourth terminal T4d of the fourth transformer 60d via the fourth feedback winding 63d. Upon the control switch 51 being turned on and thereby the electric potential of the first terminal T1d of the fourth transformer 60d becoming higher than the electric potential of the second terminal T2d, an induced voltage is generated in the fourth feedback winding 63d so that the electric potential of the fourth terminal T4d of the fourth transformer 60d becomes higher than the electric potential of the third terminal T3d. In this case, electric current is restricted by a fourth feedback diode 71d from flowing through the fourth feedback winding 63d; thus, magnetic energy is stored in the fourth input winding 61d. Further, upon the control switch 51 being turned from on to off, electric current is caused by the magnetic energy stored in the fourth input winding 61d to flow through the fourth feedback winding 63d. Moreover, as in the case of the fourth feedback winding 63d, upon the control switch 51 being turned from on to off, electric current is caused by the magnetic energy stored in the fourth input winding 61d to flow through the fourth output winding 62d as well. In addition, in the present embodiment, the third terminals T3a to T3d of the first to fourth transformers 60a to 60d correspond to “current output terminals”.

A first terminal T1e of the fifth transformer 60e is connected with a second terminal T2e of the fifth transformer 60e via the fifth input winding 61e.

Output terminals of the first transformer 60a are connected with the boost upper-arm drive circuit DCH via a first output diode 64a and a first output capacitor 65a. Output terminals of the second transformer 60b are connected with the U-phase upper-arm drive circuit DUH via a second output diode 64b and a second output capacitor 65b. Output terminals of the third transformer 60c are connected with the V-phase upper-arm drive circuit DVH via a third output diode 64c and a third output capacitor 65c. Output terminals of the fourth transformer 60d are connected with the W-phase upper-arm drive circuit DWH via a fourth output diode 64d and a fourth capacitor 65d. Output terminals of the fifth transformer 60e are connected with each of the lower-arm drive circuits DCL, DUL, DVL and DWL via a fifth output diode 64e and a fifth capacitor 65e.

The first terminals T1a to T1e of the transformers 60a to 60e are connected with a positive terminal of the low-voltage battery 42 via wires. Specifically, the first terminal T1e of the fifth transformer 60e is connected with the positive terminal of the low-voltage battery 42 via a fifth positive wire LPe. The first terminal T1a of the first transformer 60a is connected with the fifth positive wire LPe via a first positive wire LPa. That is, the first terminal T1a of the first transformer 60a is connected with the positive terminal of the low-voltage battery 42 via the first and fifth positive wires LPa and LPe. Similar to the first terminal T1a of the first transformer 60a, the first terminals T1b to T1d of the second to fourth transformers 60b to 60d are connected with the fifth positive wire LPe via corresponding second to fourth positive wires LPb to LPd. That is, the first terminals T1b to T1d of the second to fourth transformers 60b to 60d are connected with the positive terminal of the low-voltage battery 42 via the fifth positive wire LPe and the corresponding second to fourth positive wires LPb to LPd. In addition, a negative terminal of the low-voltage battery 42 is grounded.

The second terminals T2a to T2e of the transformers 60a to 60e are connected with a drain of the control switch 51 via wires. Specifically, the second terminal T2a of the first transformer 60a is connected with the drain of the control switch 51 via a first negative wire LNa. The second terminals T2b to T2e of the second to fifth transformers 60b to 60e are connected with the first negative wire LNa via corresponding second to fifth negative wires LNb to LNe. That is, the second terminals T2b to T2e of the second to fifth transformers 60b to 60e are connected with the drain of the control switch 51 via the first negative wire LNa and the corresponding second to fifth negative wires LNb to LNe. In addition, a source of the control switch 51 is grounded.

The third terminals T3a to T3d of the first to fourth transformers 60a to 60d are connected, via corresponding first to fourth feedback wires LRa to LRd, with an average value calculation unit 80 that is included in the isolated power supply apparatus 100. The first feedback diode 71a is provided to the first feedback wire LRa. Specifically, the first feedback diode 71a is provided in such a manner as to have its anode connected with the third terminal T3a of the first transformer 60a and its cathode connected with the average value calculation unit 80. The second feedback diode 71b is provided to the second feedback wire LRb. Specifically, the second feedback diode 71b is provided in such a manner as to have its anode connected with the third terminal T3b of the second transformer 60b and its cathode connected with the average value calculation unit 80. The third feedback diode 71c is provided to the third feedback wire LRc. Specifically, the third feedback diode 71c is provided in such a manner as to have its anode connected with the third terminal T3c of the third transformer 60c and its cathode connected with the average value calculation unit 80. The fourth feedback diode 71d is provided to the fourth feedback wire LRd. Specifically, the fourth feedback diode 71d is provided in such a manner as to have its anode connected with the third terminal T3d of the fourth transformer 60d and its cathode connected with the average value calculation unit 80. In addition, the average value calculation unit 80 will be described later.

The fourth terminal T4a of the first transformer 60a is grounded via a first ground wire LGa. The fourth terminal T4b of the second transformer 60b is grounded via a second ground wire LGb. The fourth terminal T4c of the third transformer 60c is grounded via a third ground wire LGc. A fourth terminal T4d of the fourth transformer 60d is grounded via a fourth ground wire LGd.

The isolated power supply apparatus 100 also includes first to fourth feedback capacitors 72a to 72d. The first feedback capacitor 72a connects the cathode of the first feedback diode 71a and the first ground wire LGa. The second feedback capacitor 72b connects the cathode of the second feedback diode 71b and the second ground wire LGb. The third feedback capacitor 72c connects the cathode of the third feedback diode 71c and the third ground wire LGc. The fourth feedback capacitor 72d connects the cathode of the fourth feedback diode 71d and the fourth ground wire LGd.

The power supply IC 50 is a single integrated circuit. The power supply IC 50 turns on and off the control switch 51 so as to feedback-control a feedback control value Vfb to a target value Vtg. In addition, in the present embodiment, the control switch 51 is turned on and off so that the feedback control value Vfb is feedback-controlled to the target value Vtg, thereby changing the voltages generated in the output windings 62a to 62e by an amount corresponding to the deviation value between the feedback control value Vfb and the target value Vtg.

Unlike in the present embodiment, a feedback winding may be provided in only one of the transformers 60a to 60e. In this case, the number of transformers whose output voltages are reflected in the feedback control value Vfb would be reduced due to the fact that only one of the transformers is provided with the feedback winding. Consequently, the voltages generated in the output windings of those of the transformers 60a to 60e which are not provided with the feedback winding might become excessively higher or excessively lower than a target output voltage. In addition, the target output voltage is set within a voltage range defined by an upper limit voltage and a lower limit voltage of the output windings 62a to 62e.

In view of the above, in the present embodiment, the first to fourth feedback windings 63a to 63d are provided respectively in the first to fourth transformers 60a to 60d; and the feedback control value Vfb is acquired based on the voltages generated in the first to fourth feedback windings 63a to 63d. Moreover, the power supply IC 50 turns on and off the control switch 51 so as to feedback-control the acquired feedback control value Vfb to the target value Vtg.

Specifically, an average control value, which correlates with an average value of the voltages generated in the first to fourth feedback windings 63a to 63d, is acquired as the feedback control value Vfb. The average value of the voltages generated in the first to fourth feedback windings 63a to 63d is calculated in the average value calculation unit 80. More specifically, the average value calculation unit 80 receives the voltages generated in the first to fourth feedback windings 63a to 63d as input values, and calculates the average value of the voltages generated in the first to fourth feedback windings 63a to 63d. Then, the power supply IC 50 acquires, based on an output value of the average value calculation unit 80, the feedback control value Vfb.

In the present embodiment, the average value calculation unit 80 includes first to fourth input resistors 81a to 81d, an operational amplifier 82 and a feedback resistor 83.

A first end of the first input resistor 81a is connected with the first feedback wire LRa; and a second end of the first input resistor 81a is connected with an inverting input terminal of the operational amplifier 82. A first end of the second input resistor 81b is connected with the second feedback wire LRb; and a second end of the second input resistor 81b is connected with the inverting input terminal of the operational amplifier 82. A first end of the third input resistor 81c is connected with the third feedback wire LRc; and a second end of the third input resistor 81c is connected with the inverting input terminal of the operational amplifier 82. A first end of the fourth input resistor 81d is connected with the fourth feedback wire LRd; and a second end of the fourth input resistor 81d is connected with the inverting input terminal of the operational amplifier 82. A non-inverting input terminal of the operational amplifier 82 is grounded. An output terminal of the operational amplifier 82 is connected with the inverting input terminal of the operational amplifier 82 via the feedback resistor 83. The resistance values of the first to fourth input resistors 81a to 81d are set to a predetermined value R0; and the resistance value of the feedback resistor 83 is set to R0/4.

The isolated power supply apparatus 100 also includes first and second voltage-dividing resistors 84 and 85. The output terminal of the operational amplifier 82 is connected with a first end of the first voltage-dividing resistor 84. A second end of the first voltage-dividing resistor 84 is connected with both a detection terminal Tfb1 of the power supply IC 50 and a first end of the second voltage-dividing resistor 85. A second end of the second voltage-dividing resistor 85 is grounded.

The divided-voltage value of the output voltage of the operational amplifier 82 is inputted to the power supply IC 50. The power supply IC 50 may acquire, as the feedback control value Vfb, a value obtained by inverting the sign of the inputted divided-voltage value. In this manner, the average control value of the voltages generated in the first to fourth feedback windings 63a to 63d is acquired. In addition, in the present embodiment, the power supply IC 50 and the average value calculation unit 80 together correspond to an “acquisition unit”.

The power supply IC 50 acquires the average control value of the voltages generated in the first to fourth feedback windings 63a to 63d as the feedback control value Vfb, and turns on and off the control switch 51 so as to feedback-control the acquired average control value to the target value Vtg. In addition, in the present embodiment, the power supply IC 50 corresponds to a “control unit”.

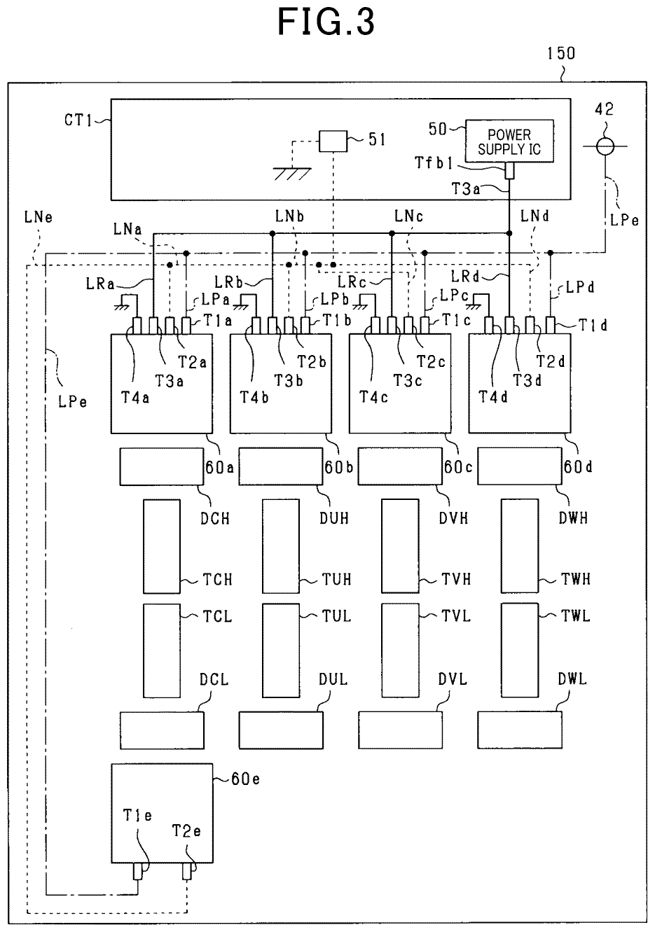

FIG. 3 is a diagram illustrating the arrangement of each component on a board 150 to which the switches SCH, SCL and SUH to SWL, the drive circuits DCH, DCL and DUH to DWL, and the isolated power supply apparatus 100 are mounted. It should be noted that in FIG. 3, the first to fourth feedback diodes 71a to 71d, the first to fourth feedback capacitors 72a to 72d, the average value calculation unit 80, and the first and second voltage-dividing resistors 84 and 85 are omitted from the illustration.

The board 150 is a rectangular multi-layer board which has a pair of outer layers and a plurality of inner layers sandwiched between the pair of outer layers. Specifically, the board 150 has, as the pair of outer layers, a first surface and a second surface that is on the back side of the first surface. On the first surface of the board 150, there are provided connection parts for connecting the switches SCH, SCL and SUH to SWL to the board 150. Specifically, a boost upper-arm connection part TCH connects the upper-arm boost switch SCH to the board 150; and a boost lower-arm connection part TCL connects the lower-arm boost switch SCL to the board 150. A U-phase upper-arm connection part TUH connects the U-phase upper-arm switch SUH to the board 150; and a U-phase lower-arm connection part TUL connects the U-phase lower-arm switch SUL to the board 150. A V-phase upper-arm connection part TVH connects the V-phase upper-arm switch SVH to the board 150; and a V-phase lower-arm connection part TVL connects the V-phase lower-arm switch SVL to the board 150. A W-phase upper-arm connection part TWH connects the W-phase upper-arm switch SWH to the board 150; and a W-phase lower-arm connection part TWL connects the W-phase lower-arm switch SWL to the board 150.

The boost upper-arm connection part TCH and the upper-arm connection parts TUH to TWH of the respective phases are provided on the board 150 such that they are aligned in a row in front view of the first surface of the board 150. Similarly, the boost lower-arm connection part TCL and the lower-arm connection parts TUL to TWL of the respective phases are provided on the board 150 such that they are aligned in a row in front view of the first surface of the board 150.

In front view of the first surface of the board 150, the first to fourth transformers 60a to 60d, which are the upper-arm transformers, are located in an area on the opposite side of the upper-arm connection parts TCH and TUH to TWH to the lower-arm connection parts TCL and TUL to TWL. Moreover, in front view of the first surface of the board 150, a power supply control unit CT1, which includes the power supply IC 50, the control switch 51 and the average value calculation unit 80, is located in an area on the opposite side of the first to fourth transformers 60a to 60d to the upper-arm connection parts TCH and TUH to TWH. In addition, the transformers 60a to 60d are provided such that the corresponding terminals T1a to T4a, T1b to T4b, T1c to T4c and T1d to T4d are adjacent to the power supply control unit CT1.

In front view of the first surface of the board 150, in an area between the upper-arm connection parts TCH and TUH to TWH that are aligned in a row and the first to fourth transformers 60a to 60d that are also aligned in a row, there are arranged the upper-arm drive circuits DCH and DUH to DWH in a row in the direction in which the upper-arm connection parts TCH and TUH to TWH are aligned.

The fifth transformer 60e, which is the sole lower-arm transformer, is located near the boost lower-arm connection part TCL in front view of the first surface of the board 150. Specifically, in front view of the first surface of the board 150, the fifth transformer 60e is located in an area on the opposite side of the boost lower-arm connection part TCL to the boost upper-arm connection part TCH. In addition, the fifth transformer 60e is provided such that the first and second terminals T1e and T2e face away from the boost lower-arm connection part TCL.

In front view of the first surface of the board 150, the lower-arm drive circuits DCL and DUL to DWL are arranged in a row in the direction in which the lower-arm connection parts TCL and TUL to TWL are aligned, and adjacent to the lower-arm connection parts TCL and TUL to TWL. In addition, the boost lower-arm drive circuit DCL is located in an area between the fifth transformer 60e and the boost lower-arm connection part TCL in front view of the first surface of the board 150

With the above arrangement, the fifth transformer 60e is located further away from the power supply control unit CT1 than the first to fourth transformers 60a to 60d are in front view of the first surface of the board 150; the fifth transformer 60e is the sole lower-arm transformer, whereas the first to fourth transformers 60a to 60d are the upper-arm transformers. Consequently, the wires extending from the power supply control unit CT1 to the terminals of the fifth transformer 60e become longer than the wires extending from the power supply control unit CT1 to the terminals of the first to fourth transformers 60a to 60d. For example, the fifth positive wire LPe is longer than the first to fourth positive wires LPa to LPd; and the fifth negative wire LNe is longer than the first to fourth negative wires LNa to LNd.

According to the present embodiment, it is possible to achieve the following advantageous effects.

In the present embodiment, the feedback control value Vfb is acquired based on the voltages generated in the first to fourth feedback windings 63a to 63d. Consequently, it becomes possible to perform the feedback control with the feedback control value Vfb reflecting the voltages generated in more feedback windings than in the case of the feedback control value Vfb being acquired based on the voltage generated in a single feedback winding. Hence, it becomes possible to prevent the voltages generated in the first to fourth output windings 62a to 62d from becoming excessively higher or excessively lower than the target output voltage. As a result, it becomes possible to improve the controllability of the voltages generated in the first to fourth output windings 62a to 62d.

In the case of the first to fourth feedback windings 63a to 63d being provided in the first to fourth transformers 60a to 60d, the voltages generated in the first to fourth feedback windings 63a to 63d are reflected in the feedback control value Vfb. Therefore, the voltages generated in the first to fourth output windings 62a to 62d can be prevented from becoming excessively higher or excessively lower than the target output voltage. On the other hand, there is no feedback winding provided in the fifth transformer 60e. Therefore, when the amount of change in the voltages generated in the first to fourth output windings 62a to 62d during the feedback control is large, the voltage generated in the fifth output winding 62e may become excessively higher or excessively lower than the target output voltage.

In view of the above, in the present embodiment, the average control value of the voltages generated in the first to fourth feedback windings 63a to 63d is acquired as the feedback control value Vfb. Consequently, even if there is, among the first to fourth transformers 60a to 60d, a transformer in which the voltage generated in the output winding largely deviates from the target output voltage, the feedback control value Vfb can still be prevented from largely deviating from the target value Vtg. Hence, with the acquired feedback control value Vfb being feedback-controlled to the target value Vtg, increase in the amount of change in the voltages generated in the output windings 62a to 62e during the feedback control can be suppressed. As a result, in the fifth transformer 60e having no feedback winding as well as in the first to fourth transformers 60a to 60d, the voltages generated in the output windings 62a to 62e can be prevented from becoming excessively higher or excessively lower than the target output voltage.

One may consider providing feedback windings in, among the transformers 60a to 60e, at least two transformers including the fifth transformer 60e and acquiring the feedback control value Vfb based on the voltages generated in the feedback windings. However, in this case, it would become necessary to provide a feedback wire connected with the fifth transformer 60e; thus, the total length of the wires provided in the isolated power supply apparatus 100 would be increased. Consequently, the amount of voltage drop in the wires might be increased and/or noise might be superimposed on electric current flowing through the wires.

In view of the above, in the present embodiment, the first to fourth feedback windings 63a to 63d are provided respectively in the first to fourth transformers 60a to 60d. Consequently, it becomes possible to prevent the feedback wires provided in the isolated power supply apparatus 100 from becoming long. Moreover, since the average control value of the voltages generated in the first to fourth feedback windings 63a to 63d is acquired as the feedback control value Vfb, it also becomes possible to suppress increase in the amount of change in the voltage generated in the fifth output winding 62e of the fifth transformer 60e that has no feedback winding. As a result, it becomes possible to suppress increase in the amount of change in the voltages generated in the output windings 62a to 62e during the feedback control while suppressing increase in the amount of voltage drop in the wires provided in the isolated power supply apparatus 100 and superimposition of noise on electric current flowing through the wires.

### Second Embodiment

Hereinafter, the second embodiment will be described with reference to the drawings, focusing on the differences thereof from the first embodiment.

An overvoltage abnormality is most likely to occur in that one of the transformers 60a to 60e whose output voltage is highest. Therefore, in the case of the first to fourth feedback windings 63a to 63d being provided respectively in the first to fourth transformers 60a to 60d, it may be desirable to acquire, as the feedback control value Vfb, the voltage generated in the feedback winding provided in that one of the first to fourth transformers 60a to 60d whose output voltage is highest.

In view of the above, in the present embodiment, a maximum control value, which correlates with a maximum value of the voltages generated in the first to fourth feedback windings 63a to 63d, is acquired instead of the average control value of the voltages generated in the first to fourth feedback windings 63a to 63d.

To acquire the maximum control value of the voltages generated in the first to fourth feedback windings 63a to 63d, one may consider adding to the isolated power supply apparatus 100 a circuit that performs a calculation process for calculating the maximum value of the voltages generated in the first to fourth feedback windings 63a to 63d. However, in this case, the number of parts of the isolated power supply apparatus 100 would be increased.

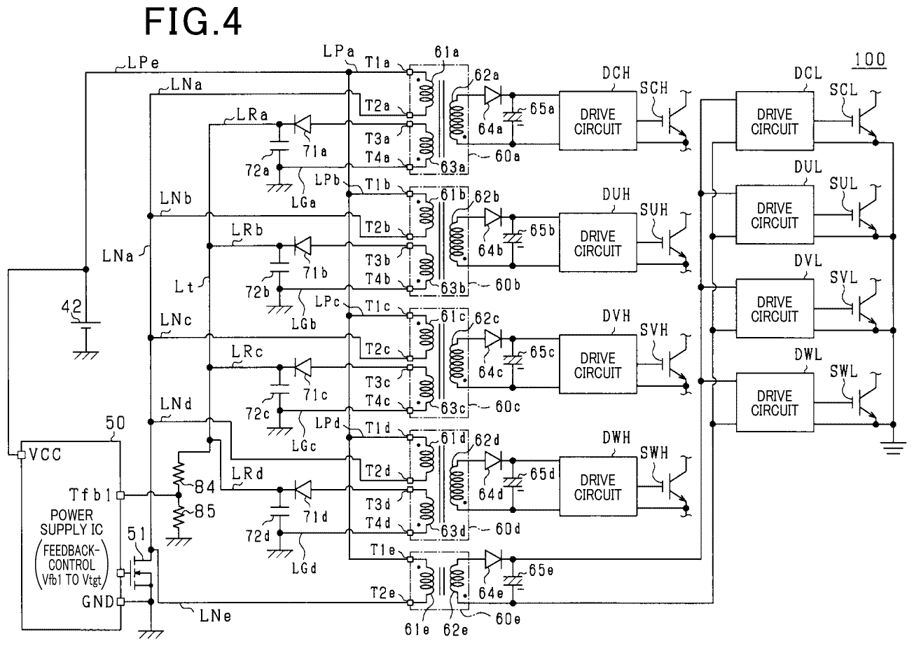

In view of the above, in the present embodiment, as shown in FIG. 4, the maximum control value of the voltages generated in the first to fourth feedback windings 63a to 63d is acquired by connecting the first to fourth feedback windings 63a to 63d in parallel to each other. Specifically, in the present embodiment, the isolated power supply apparatus 100 includes a common wire Lt that is connected with the first end of the first voltage-dividing resistor 84. The first feedback wire LRa is connected with the common wire Lt, instead of being connected with the first end of the first input resistor 81a of the average value calculation unit 80 as in the first embodiment. The second feedback wire LRb is also connected with the common wire Lt, instead of being connected with the first end of the second input resistor 81b of the average value calculation unit 80 as in the first embodiment. The third feedback wire LRc is also connected with the common wire Lt, instead of being connected with the first end of the third input resistor 81c of the average value calculation unit 80 as in the first embodiment. The fourth feedback wire LRd is also connected with the common wire Lt, instead of being connected with the first end of the fourth input resistor 81d of the average value calculation unit 80 as in the first embodiment. The voltage of the common wire Lt is inputted to the power supply IC 50 via the first and second voltage-dividing resistors 84 and 85.

With the above configuration, the voltage generated in the first feedback winding 63a is inputted to the power supply IC 50 via the first feedback diode 71a provided to the first feedback wire LRa. The voltage generated in the second feedback winding 63b is inputted to the power supply IC 50 via the second feedback diode 71b provided to the second feedback wire LRb. The voltage generated in the third feedback winding 63c is inputted to the power supply IC 50 via the third feedback diode 71c provided to the third feedback wire LRc. The voltage generated in the fourth feedback winding 63d is inputted to the power supply IC 50 via the fourth feedback diode 71d provided to the fourth feedback wire LRd. The first to fourth feedback diodes 71a to 71d are provided in such a manner as to allow electric current to flow from the corresponding feedback windings 63a to 63d to the power supply IC 50. Therefore, electric current flows from that one of the feedback windings 63a to 63d where the highest voltage is generated to the power supply IC 50. As a result, in the power supply IC 50, the maximum control value is acquired which results from the division of the maximum value of the voltages generated in the first to fourth feedback windings 63a to 63d by the first and second voltage-dividing resistors 84 and 85.

According to the present embodiment, it is possible to achieve the following advantageous effects.

In the present embodiment, the maximum control value of the voltages generated in the first to fourth feedback windings 63a to 63d is acquired as the feedback control value Vfb. Then, the acquired feedback control value Vfb is feedback-controlled to the target value Vtg. Consequently, among the first to fourth transformers 60a to 60d, the transformer which includes that one of the first to fourth output windings 62a to 62d where the highest voltage is generated becomes the target of the feedback control. As a result, it becomes possible to prevent an overvoltage abnormality from occurring in the first to fourth transformers 60a to 60d.

In the present embodiment, the maximum control value of the voltages generated in the first to fourth feedback windings 63a to 63d is acquired by connecting the first to fourth feedback windings 63a to 63d in parallel to each other. Consequently, it becomes possible to acquire the maximum control value of the voltages generated in the first to fourth feedback windings 63a to 63d while suppressing increase in the number of parts of the isolated power supply apparatus 100, compared to the case of adding to the isolated power supply apparatus 100 a circuit that calculates the maximum value of the voltages generated in the first to fourth feedback windings 63a to 63d.

Situations may happen where an open circuit fault occurs in the feedback windings, making it impossible to continue the feedback control. In this regard, in the present embodiment, the first to fourth feedback windings 63a to 63d are provided respectively in the first to fourth transformers 60a to 60d. Consequently, even if an open circuit fault occurs in one of the first to fourth feedback windings 63a to 63d, the feedback control can still be continued by acquiring the maximum control value of the voltages generated in those of the first to fourth feedback windings 63a to 63d which are in a normal condition.

In the present embodiment, the first to fourth feedback windings 63a to 63d are provided respectively in the first to fourth transformers 60a to 60d as in the first embodiment. Consequently, it becomes possible to prevent an overvoltage abnormality from occurring in the first to fourth transformers 60a to 60d while suppressing increase in the amount of voltage drop in the wires provided in the isolated power supply apparatus 100 and superimposition of noise on electric current flowing through the wires.

### Third Embodiment

Hereinafter, the third embodiment will be described with reference to the drawings, focusing on the differences thereof from the first embodiment.

In the case of the feedback control value Vfb being acquired based on the voltages generated in the first to fourth feedback windings 63a to 63d, the amount of change in the feedback control value Vfb may become large due to load fluctuation in the upper-arm drive circuits DCH and DUH to DWH. In this case, the amount of change in the voltages generated in the output windings 62a to 62e during the feedback control may become large. Therefore, it may be desirable to reduce the amount of change in the voltages generated in the output windings 62a to 62e during the feedback control with respect to the amount of change in the feedback control value Vfb.

In view of the above, in the present embodiment, instead of acquiring the average control value of the voltages generated in the first to fourth feedback windings 63a to 63d, a total control value, which correlates with the sum of the voltages generated in the first to fourth feedback windings 63a to 63d, is acquired as the feedback control value Vfb.

To acquire the total control value of the voltages generated in the first to fourth feedback windings 63a to 63d, one may consider adding to the isolated power supply apparatus 100 a circuit that performs a calculation process for calculating the sum of the voltages generated in the first to fourth feedback windings 63a to 63d. However, in this case, the number of parts of the isolated power supply apparatus 100 would be increased.

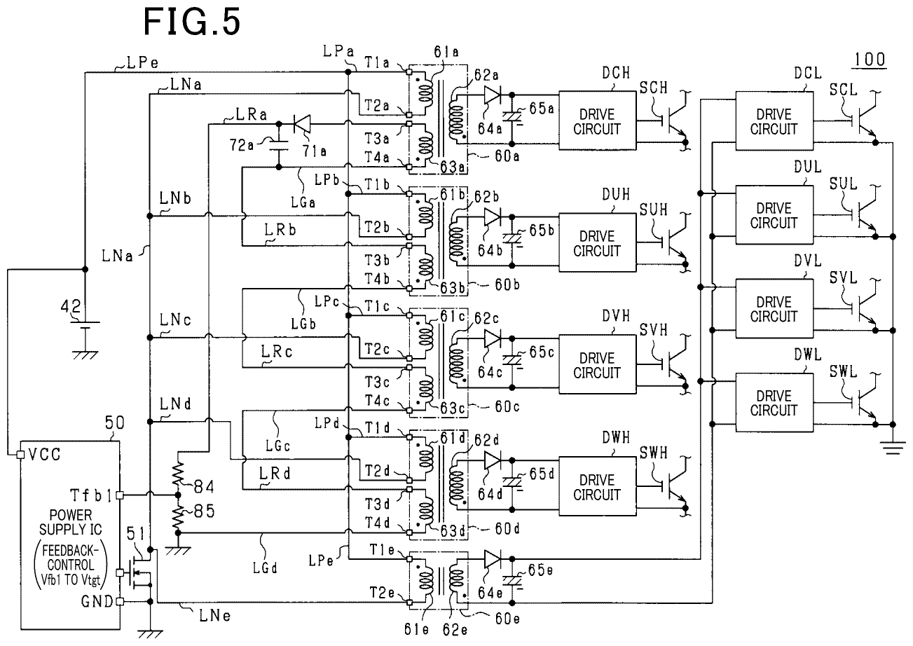

In view of the above, in the present embodiment, as shown in FIG. 5, the total control value of the voltages generated in the first to fourth feedback windings 63a to 63d is acquired by connecting the first to fourth feedback windings 63a to 63d in series with each other. Specifically, in the present embodiment, the first feedback wire LRa is connected with the first end of the first voltage-dividing resistor 84, instead of being connected with the first end of the first input resistor 81a of the average value calculation unit 80 as in the first embodiment. The first ground wire LGa is connected with the second feedback wire LRb, instead of being grounded as in the first embodiment. The second ground wire LGb is connected with the third feedback wire LRc, instead of being grounded as in the first embodiment. The third ground wire LGc is connected with the fourth feedback wire LRd, instead of being grounded as in the first embodiment. The fourth ground wire LGd is connected with both the second end of the second voltage-dividing resistor 85 and the ground. The voltage of the first feedback wire LRa is inputted to the power supply IC 50 via the first and second voltage-dividing resistors 84 and 85.

In addition, in the present embodiment, the isolated power supply apparatus 100 does not include the second to fourth feedback diodes 71b to 71d and the second to fourth feedback capacitors 72b to 72d.

With the above configuration, since the first to fourth feedback windings 63a to 63d are connected in series with each other, the sum of the voltages generated in the first to fourth feedback windings 63a to 63d is produced between the third terminal T3a of the first transformer 60a and the fourth terminal T4d of the fourth transformer 60d. The power supply IC 50 acquires, as the feedback control value Vfb, the total control value that results from the division of the sum of the voltages generated in the first to fourth feedback windings 63a to 63d by the first and second voltage-dividing resistors 84 and 85. Then, the power supply IC 50 turns on and off the control switch 51 so as to feedback-control the acquired feedback control value Vfb to the target value Vtg. More particularly, in the present embodiment, the control switch 51 is turned on and off so that the feedback control value Vfb is feedback-controlled to the target value Vtg, thereby changing the voltages generated in the output windings 62a to 62e by an amount corresponding to one-fourth of the deviation value between the feedback control value Vfb and the target value Vtg.

According to the present embodiment, it is possible to achieve the following advantageous effects.

In the present embodiment, the total control value of the voltages generated in the first to fourth feedback windings 63a to 63d is acquired as the feedback control value Vfb. Then, the acquired feedback control value Vfb is feedback-controlled to the target value Vtg. Specifically, in order to feedback-control the feedback control value Vfb to the target value Vtg, the control switch 51 is turned on and off in such as manner as to change the voltages generated in the output windings 62a to 62e by an amount corresponding to one-fourth of the deviation value between the feedback control value Vfb and the target value Vtg. Consequently, it becomes possible to reduce the amount of change in the voltages generated in the output windings 62a to 62e during the feedback control with respect to the amount of change in the feedback control value Vfb. As a result, it becomes possible to prevent the voltages generated in the output windings 62a to 62e from becoming excessively higher or excessively lower than the target output voltage.

In the present embodiment, the total control value of the voltages generated in the first to fourth feedback windings 63a to 63d is acquired by connecting the first to fourth feedback windings 63a to 63d in series with each other. Consequently, it becomes possible to acquire the total control value of the voltages generated in the first to fourth feedback windings 63a to 63d while suppressing increase in the number of parts of the isolated power supply apparatus 100.

In the present embodiment, the first to fourth feedback windings 63a to 63d are provided respectively in the first to fourth transformers 60a to 60d as in the first embodiment. Consequently, it becomes possible to reduce the amount of change in the voltages generated in the output windings 62a to 62e during the feedback control with respect to the amount of change in the feedback control value Vfb, while suppressing increase in the amount of voltage drop in the wires provided in the isolated power supply apparatus 100 and superimposition of noise on electric current flowing through the wires.

### Fourth Embodiment

Hereinafter, the fourth embodiment will be described with reference to the drawings, focusing on the differences thereof from the first embodiment.

In the case of a feedback winding being provided in only one of the transformers 60a to 60e, the output voltages of the transformers 60a to 60e may change significantly due to load fluctuation in the drive circuit(s) connected with the transformer in which the feedback winding is provided. Specifically, when the drive circuit(s) stop(s) operating or operate(s) under a high load, the output voltage of the transformer connected with the drive circuit(s) may change significantly. Moreover, the fifth output winding 62e of the fifth transformer 60e is connected with four drive circuits, whereas each of the first to fourth output windings 62a to 62d of the first to fourth transformers 60a to 60d is connected with a single drive circuit. Therefore, in the fifth transformer 60e, overall load fluctuation in the four drive circuits connected with the fifth output winding 62e may be reduced compared to the first to fourth transformers 60a to 60d. Therefore, it may be desirable to set, among the transformers 60a to 60e, the fifth transformer 60e which has the maximum number of drive circuits connected with the output winding thereof as the target of the feedback control.

In view of the above, in the present embodiment, a feedback winding is provided in only the fifth transformer 60e which has the maximum number of drive circuits connected with the output winding thereof among the transformers 60a to 60e. In addition, in the present embodiment, the fifth transformer 60e corresponds to a “specific transformer”.

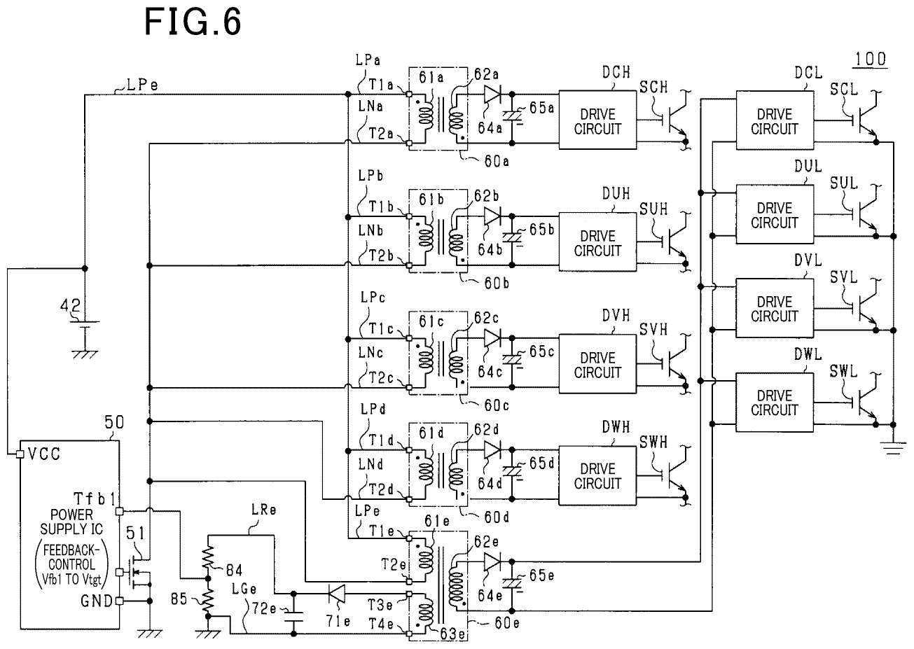

Specifically, in the present embodiment, as shown in FIG. 6, the fifth transformer 60e includes a fifth feedback winding 63e. The fifth feedback winding 63e is wound, together with the fifth input winding 61e and the fifth output winding 62e, around a common core; and the fifth input winding 61e, the fifth output winding 62e and the fifth feedback winding 63e are magnetically coupled by the common core.

A third terminal T3e of the fifth transformer 60e is connected with a fourth terminal T4e of the fifth transformer 60e via the fifth feedback winding 63e. The third terminal T3e of the fifth transformer 60e is also connected with the first end of the first voltage-dividing resistor 84 via a fifth feedback wire LRe. The fourth terminal T4e of the fifth transformer 60e is connected, via a fifth ground wire LGe, with both the second end of the second voltage-dividing resistor 85 and the ground.

A fifth feedback diode 71e is provided to the fifth feedback wire LRe. Specifically, the fifth feedback diode 71e is provided in such a manner as to have its anode connected with the third terminal T3e of the fifth transformer 60e and its cathode connected with the first end of the first voltage-dividing resistor 84. Moreover, the cathode of the fifth feedback diode 71e and the fifth ground wire LGe are connected by a fifth feedback capacitor 72e.

With the above configuration, the voltage generated in the fifth feedback winding 63e is inputted to the power supply IC 50 via the first and second voltage-dividing resistors 84 and 85. Consequently, the divided-voltage value of the voltage generated in the fifth feedback winding 63e is acquired as the feedback control value Vfb.

According to the present embodiment, the fifth feedback winding 63e is provided in the fifth transformer 60e which has the maximum number of drive circuits connected therewith among the transformers 60a to 60e. Consequently, compared to the case of a feedback winding being provided in one of the first to fourth transformers 60a to 60d, it becomes possible to suppress overall load fluctuation in the drive circuits DCL and DUL to DWL connected with the fifth output winding 62e, thereby suppressing change in the voltage generated in the fifth output winding 62e. Thus, it also becomes possible to suppress change in the voltage generated in the fifth feedback winding 63e, thereby suppressing change in the feedback control value Vfb. Hence, it becomes possible to suppress the deviation of the feedback control value Vfb from the target value Vtg, thereby suppressing increase in the amount of change in the voltages generated in the output windings 62a to 62e during the feedback control. As a result, it becomes possible to prevent the voltages generated in the output windings 62a to 62e from becoming excessively higher or excessively lower than the target output voltage, thereby improving the controllability of the voltages generated in the output windings 62a to 62e.

### Other Embodiments

The above-described embodiments may be implemented through the following modifications.

In the first to third embodiments, the first to fourth feedback windings 63a to 63d are provided respectively in the first to fourth transformers 60a to 60d. However, the present disclosure is not limited to this configuration. For example, four feedback windings may be provided respectively in, among the transformers 60a to 60e, four transformers including the fifth transformer 60e. Moreover, two or three feedback windings may be provided respectively in any two or three of the transformers 60a to 60e. Alternatively, each of the transformers 60a to 60e may have a feedback winding provided therein.

In the first embodiment, the isolated power supply apparatus 100 may not include the first and second voltage-dividing resistors 84 and 85. In this case, the output voltage of the operational amplifier 82 would be inputted to the power supply IC 50. Consequently, the average value of the voltages generated in the first to fourth feedback windings 63a to 63d would be acquired as the feedback control value Vfb.

In the second embodiment, the isolated power supply apparatus 100 may not include the first and second voltage-dividing resistors 84 and 85. In this case, the voltage of the common wire Lt would be inputted to the power supply IC 50. Consequently, the maximum value of the voltages generated in the first to fourth feedback windings 63a to 63d would be acquired as the feedback control value Vfb.

In the third embodiment, the isolated power supply apparatus 100 may not include the first and second voltage-dividing resistors 84 and 85. In this case, the voltage of the first feedback wire LRa would be inputted to the power supply IC 50. Consequently, the sum of the voltages generated in the first to fourth feedback windings 63a to 63d that are connected in series with each other would be acquired as the feedback control value Vfb.

The application of the isolated power supply apparatus 100 is not limited to the inverter 12 and the boost converter 30. For example, the isolated power supply apparatus 100 may alternatively be applied to other electric power conversion circuits, such as a half-bridge circuit or a full-bridge circuit. Moreover, the switches SCH, SCL and SUH to SWL constituting the inverter 12 and the boost converter 30 are not limited to IGBTs, but may alternatively be implemented by, for example, MOSFETs.

The power supply targets to which the output voltages of the transformers 60a to 60e are supplied are not limited to the drive circuits DCH, DCL and DUH to DWL, but may alternatively be general electrical loads. Specific examples of general electrical loads may include seat heaters, heaters for rear window defrosters, headlights, windshield wipers and air conditioner fans.

The object in which the isolated power supply apparatus 100 is installed is not limited to a vehicle, but may alternatively be, for example, an aircraft or a ship. Furthermore, the object in which the isolated power supply apparatus 100 is installed is not limited to a mobile object such a vehicle, an aircraft or a ship.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. An isolated power supply apparatus comprising:
a plurality of transformers;
a control switch;
an acquisition unit; and
a control unit,
wherein
input sides of the transformers are connected with a DC power source and output sides of the transformers are connected with power supply targets corresponding to the transformers,
at least two of the transformers have respective feedback windings,
the control switch is configured to allow supply of electric power from the DC power source to the input sides of the transformers by being turned on and interrupt the supply of electric power from the DC power source to the input sides of the transformers by being turned off,
the acquisition unit is configured to acquire, based on voltages generated in the feedback windings, a control value for feedback control, and
the control unit is configured to turn on and off the control switch so as to feedback-control the control value to a target value and thereby control voltages on the output sides of the transformers,
wherein
the acquisition unit is configured to acquire, as the control value, a maximum control value that is either a maximum value of the voltages generated in the feedback windings or a correlation value of the maximum value, and
the control unit is configured to turn on and off the control switch so as to feedback-control the maximum control value to the target value,
wherein
the isolated power supply apparatus further comprises:
feedback wires provided respectively corresponding to the feedback windings;
a common wire connected with first ends of the feedback wires; and
diodes each of which is provided to a corresponding one of the feedback wires,
wherein
each of the feedback windings has two ends one of which constitutes a current output terminal and the other of which is grounded,
second ends of the feedback wires are connected respectively with the current output terminals of the corresponding feedback windings,
each of the diodes has its anode oriented toward the current output terminal of a corresponding one of the feedback windings, and
the acquisition unit is configured to acquire, as the maximum control value, a voltage value inputted thereto from the common wire.

2. The isolated power supply apparatus as set forth in claim 1, wherein
at least three of the transformers have the respective feedback windings.

3. The isolated power supply apparatus as set forth in claim 1, wherein
the isolated power supply apparatus is applied to a system comprising:
an electric power conversion circuit having upper-arm switches and lower-arm switches;
upper-arm drive circuits each of which is one of the power supply targets and configured to drive a corresponding one of the upper-arm switches;
lower-arm drive circuits each of which is one of the power supply targets and configured to drive a corresponding one of the lower-arm switches; and
a board to which the upper-arm and lower-arm switches, the upper-arm and lower-arm drive circuits and the isolated power supply apparatus are mounted,
wherein
the transformers include:
upper-arm transformers each of which is provided on the board and has the input side thereof connected with the DC power source and the output side thereof connected with a corresponding one of the upper-arm drive circuits; and
a lower-arm transformer that is provided on the board and has the input side thereof connected with the DC power source and the output side thereof connected with the lower-arm drive circuits,
wherein
the isolated power supply apparatus further comprises an integrated circuit that is provided on the board and includes the acquisition unit and the control unit,
the upper-arm transformers are located adjacent to the integrated circuit in front view of a board surface of the board,
the lower-arm transformer is located further away from the integrated circuit than the upper-arm transformers are in front view of the board surface of the board, and
of the upper-arm transformers and the lower-arm transformer, at least two upper-arm transformers have the respective feedback windings.

4. An isolated power supply apparatus comprising:
a plurality of transformers;
a control switch;
an acquisition unit; and
a control unit,
wherein
input sides of the transformers are connected with a DC power source and output sides of the transformers are connected with power supply targets corresponding to the transformers,
at least two of the transformers have respective feedback windings,
the control switch is configured to allow supply of electric power from the DC power source to the input sides of the transformers by being turned on and interrupt the supply of electric power from the DC power source to the input sides of the transformers by being turned off,
the acquisition unit is configured to acquire, based on voltages generated in the feedback windings, a control value for feedback control, and
the control unit is configured to turn on and off the control switch so as to feedback-control the control value to a target value and thereby control voltages on the output sides of the transformers,
wherein
the acquisition unit is configured to acquire, as the control value, a total control value that is either a sum of the voltages generated in the feedback windings or a correlation value of the sum, and
the control unit is configured to turn on and off the control switch so as to feedback-control the total control value to the target value,
wherein
the isolated power supply apparatus further comprises electrical paths that connect the feedback windings in series with each other, and
the acquisition unit is configured to acquire, as the total control value, a voltage value inputted thereto from the electrical paths.

5. The isolated power supply apparatus as set forth in claim 4, wherein
the isolated power supply apparatus is applied to a system comprising:
an electric power conversion circuit having upper-arm switches and lower-arm switches;
upper-arm drive circuits each of which is one of the power supply targets and configured to drive a corresponding one of the upper-arm switches;
lower-arm drive circuits each of which is one of the power supply targets and configured to drive a corresponding one of the lower-arm switches; and
a board to which the upper-arm and lower-arm switches, the upper-arm and lower-arm drive circuits and the isolated power supply apparatus are mounted,
wherein
the transformers include:
upper-arm transformers each of which is provided on the board and has the input side thereof connected with the DC power source and the output side thereof connected with a corresponding one of the upper-arm drive circuits; and
a lower-arm transformer that is provided on the board and has the input side thereof connected with the DC power source and the output side thereof connected with the lower-arm drive circuits,
wherein
the isolated power supply apparatus further comprises an integrated circuit that is provided on the board and includes the acquisition unit and the control unit,
the upper-arm transformers are located adjacent to the integrated circuit in front view of a board surface of the board,
the lower-arm transformer is located further away from the integrated circuit than the upper-arm transformers are in front view of the board surface of the board, and
of the upper-arm transformers and the lower-arm transformer, at least two upper-arm transformers have the respective feedback windings.

6. An isolated power supply apparatus comprising:
a plurality of transformers;
a control switch;
an acquisition unit; and
a control unit,
wherein
input sides of the transformers are connected with a DC power source and output sides of the transformers are connected with power supply targets corresponding to the transformers,
at least two of the transformers have respective feedback windings,
the control switch is configured to allow supply of electric power from the DC power source to the input sides of the transformers by being turned on and interrupt the supply of electric power from the DC power source to the input sides of the transformers by being turned off,
the acquisition unit is configured to acquire, based on voltages generated in the feedback windings, a control value for feedback control, and
the control unit is configured to turn on and off the control switch so as to feedback-control the control value to a target value and thereby control voltages on the output sides of the transformers,
wherein
the acquisition unit is configured to acquire, as the control value, an average control value that is either an average value of the voltages generated in the feedback windings or a correlation value of the average value, and
the control unit is configured to turn on and off the control switch so as to feedback-control the average control value to the target value,
wherein
the isolated power supply apparatus is applied to a system comprising:
an electric power conversion circuit having upper-arm switches and lower-arm switches;
upper-arm drive circuits each of which is one of the power supply targets and configured to drive a corresponding one of the upper-arm switches;
lower-arm drive circuits each of which is one of the power supply targets and configured to drive a corresponding one of the lower-arm switches; and
a board to which the upper-arm and lower-arm switches, the upper-arm and lower-arm drive circuits and the isolated power supply apparatus are mounted,
wherein
the transformers include:
upper-arm transformers each of which is provided on the board and has the input side thereof connected with the DC power source and the output side thereof connected with a corresponding one of the upper-arm drive circuits; and
a lower-arm transformer that is provided on the board and has the input side thereof connected with the DC power source and the output side thereof connected with the lower-arm drive circuits,
wherein
the isolated power supply apparatus further comprises an integrated circuit that is provided on the board and includes the acquisition unit and the control unit,
the upper-arm transformers are located adjacent to the integrated circuit in front view of a board surface of the board,
the lower-arm transformer is located further away from the integrated circuit than the upper-arm transformers are in front view of the board surface of the board, and
of the upper-arm transformers and the lower-arm transformer, at least two upper-arm transformers have the respective feedback windings.

7. An isolated power supply apparatus comprising:
a plurality of transformers;
a control switch;
an acquisition unit; and
a control unit,
wherein
input sides of the transformers are connected with a DC power source and output sides of the transformers are connected with power supply targets corresponding to the transformers,
at least two of the transformers have respective feedback windings,
the control switch is configured to allow supply of electric power from the DC power source to the input sides of the transformers by being turned on and interrupt the supply of electric power from the DC power source to the input sides of the transformers by being turned off,
the acquisition unit is configured to acquire, based on voltages generated in the feedback windings, a control value for feedback control, and
the control unit is configured to turn on and off the control switch so as to feedback-control the control value to a target value and thereby control voltages on the output sides of the transformers,
wherein
the acquisition unit is configured to acquire, as the control value, a maximum control value that is either a maximum value of the voltages generated in the feedback windings or a correlation value of the maximum value, and
the control unit is configured to turn on and off the control switch so as to feedback-control the maximum control value to the target value,
wherein
the isolated power supply apparatus is applied to a system comprising:
an electric power conversion circuit having upper-arm switches and lower-arm switches;
upper-arm drive circuits each of which is one of the power supply targets and configured to drive a corresponding one of the upper-arm switches;
lower-arm drive circuits each of which is one of the power supply targets and configured to drive a corresponding one of the lower-arm switches; and
a board to which the upper-arm and lower-arm switches, the upper-arm and lower-arm drive circuits and the isolated power supply apparatus are mounted,
wherein
the transformers include:
upper-arm transformers each of which is provided on the board and has the input side thereof connected with the DC power source and the output side thereof connected with a corresponding one of the upper-arm drive circuits; and
a lower-arm transformer that is provided on the board and has the input side thereof connected with the DC power source and the output side thereof connected with the lower-arm drive circuits,
wherein
the isolated power supply apparatus further comprises an integrated circuit that is provided on the board and includes the acquisition unit and the control unit,
the upper-arm transformers are located adjacent to the integrated circuit in front view of a board surface of the board,
the lower-arm transformer is located further away from the integrated circuit than the upper-arm transformers are in front view of the board surface of the board, and
of the upper-arm transformers and the lower-arm transformer, at least two upper-arm transformers have the respective feedback windings.

8. An isolated power supply apparatus comprising:
a plurality of transformers;
a control switch;
an acquisition unit; and
a control unit,
wherein
input sides of the transformers are connected with a DC power source and output sides of the transformers are connected with power supply targets corresponding to the transformers,
at least two of the transformers have respective feedback windings,
the control switch is configured to allow supply of electric power from the DC power source to the input sides of the transformers by being turned on and interrupt the supply of electric power from the DC power source to the input sides of the transformers by being turned off,
the acquisition unit is configured to acquire, based on voltages generated in the feedback windings, a control value for feedback control, and
the control unit is configured to turn on and off the control switch so as to feedback-control the control value to a target value and thereby control voltages on the output sides of the transformers,
wherein
the acquisition unit is configured to acquire, as the control value, a total control value that is either a sum of the voltages generated in the feedback windings or a correlation value of the sum, and
the control unit is configured to turn on and off the control switch so as to feedback-control the total control value to the target value,
wherein
the isolated power supply apparatus is applied to a system comprising:
an electric power conversion circuit having upper-arm switches and lower-arm switches;
upper-arm drive circuits each of which is one of the power supply targets and configured to drive a corresponding one of the upper-arm switches;
lower-arm drive circuits each of which is one of the power supply targets and configured to drive a corresponding one of the lower-arm switches; and
a board to which the upper-arm and lower-arm switches, the upper-arm and lower-arm drive circuits and the isolated power supply apparatus are mounted,
wherein
the transformers include:
upper-arm transformers each of which is provided on the board and has the input side thereof connected with the DC power source and the output side thereof connected with a corresponding one of the upper-arm drive circuits; and
a lower-arm transformer that is provided on the board and has the input side thereof connected with the DC power source and the output side thereof connected with the lower-arm drive circuits,
wherein
the isolated power supply apparatus further comprises an integrated circuit that is provided on the board and includes the acquisition unit and the control unit,
the upper-arm transformers are located adjacent to the integrated circuit in front view of a board surface of the board,
the lower-arm transformer is located further away from the integrated circuit than the upper-arm transformers are in front view of the board surface of the board, and
of the upper-arm transformers and the lower-arm transformer, at least two upper-arm transformers have the respective feedback windings.

9. An isolated power supply apparatus comprising:
a plurality of transformers;
a control switch;
an acquisition unit; and
a control unit,
wherein
input sides of the transformers are connected with a DC power source and output sides of the transformers are connected with power supply targets corresponding to the transformers,
at least two of the transformers have different numbers of the power supply targets connected therewith,
a specific transformer, which has a maximum number of the power supply targets connected with the output side thereof among the transformers, has a feedback winding,
the control switch is configured to allow supply of electric power from the DC power source to the input sides of the transformers by being turned on and interrupt the supply of electric power from the DC power source to the input sides of the transformers by being turned off,
the acquisition unit is configured to acquire, based on a voltage generated in the feedback winding, a control value for feedback control, and
the control unit is configured to turn on and off the control switch so as to feedback-control the control value to a target value and thereby control voltages on the output sides of the transformers.

10. The isolated power supply apparatus as set forth in claim 9, wherein
the isolated power supply apparatus is applied to a system comprising:
an electric power conversion circuit having a plurality of series connection units each consisting of an upper-arm switch and a lower-arm switch;
a plurality of upper-arm drive circuits each of which is one of the power supply targets and configured to drive a corresponding one of the upper-arm switches of the series connection units; and
a plurality of lower-arm drive circuits each of which is one of the power supply targets and configured to drive a corresponding one of the lower-arm switches of the series connection units,
the transformers include:
upper-arm transformers the input sides of which are connected with the DC power source and the output sides of which are connected with the upper-arm drive circuits; and
a lower-arm transformer the input side of which is connected with the DC power source and the output side of which is connected with the lower-arm drive circuits,
wherein
the upper-arm transformers are provided individually respectively corresponding to the upper-arm drive circuits,
the lower-arm transformer is provided as a common transformer to all the lower-arm drive circuits, and
the specific transformer is, among the upper-arm transformers and the lower-arm transformer, the lower-arm transformer.
